(19) United States
(12) Patent Application Publication
(10) Pub. No.: US 2020/0402089 A1
(43) Pub. Date: Dec. 24, 2020

(54) SYSTEM AND METHOD FOR MONITORING VEHICLE USAGE

(71) Applicant: BEIJING DIDI INFINITY TECHNOLOGY AND DEVELOPMENT CO., LTD., Beijing (CN)

(72) Inventors: Huiyang ZHANG, Beijing (CN); Hailiang WANG, Beijing (CN); Wenxiang WANG, Beijing (CN); Xing YUE, Beijing (CN); Maomin REN, Beijing (CN); Jiajie LI, Beijing (CN); Tingfei GU, Beijing (CN)

(73) Assignee: BEIJING DIDI INFINITY TECHNOLOGY AND DEVELOPMENT CO., LTD., Beijing (CN)

(21) Appl. No.: 17/013,932

(22) Filed: Sep. 8, 2020

Related U.S. Application Data
(63) Continuation of application No. PCT/CN2018/078413, filed on Mar. 8, 2018.

(51) Int. Cl. G06Q 30/02; G06Q 10/06; G06Q 50/30

(52) U.S. Cl. CPC G06Q 30/0207; G06Q 50/30; G06Q 10/06315; G06Q 10/063114

(57) ABSTRACT

Systems and methods are provided for monitoring vehicle usage. An exemplary method implementable by a server may comprise: obtaining information of one or more vehicles available to provide transportation and one or more transportation requests; matching one or more of the transportation requests with one of the vehicles to determine a planned transportation; determining a first reward to a first user associated with the matched vehicle and a second reward to one or more second users associated with the matched transportation requests; obtaining tracking data of the matched vehicle to determine whether the matched vehicle has started and ended a transportation in compliance with the planned transportation; and in response to determining that the matched vehicle has started and ended the transportation in compliance with the planned transportation, transferring the first reward to the first user and transferring the second reward to the one or more second users.

### CROSS-REFERENCE TO RELATED APPLICATIONS

This application is a continuation of International Application No. PCT/CN2018/078413, filed on Mar. 8, 2018, the contents of which are incorporated herein by reference in entirety.

### TECHNICAL FIELD

This disclosure generally relates to methods and devices for monitoring vehicle usage.

### BACKGROUND

Company employees may sometimes use private vehicles for company-related purposes. For example, an employee may drive her car from her company to a bank to secure loans for the company. In such situations, the employee's contribution to the company in the form of private vehicle usage is traditionally difficult to track or often overlooked. Current technologies are inadequate to provide a convenient and robust solution for monitoring such non-personal vehicle usage. Existing online vehicle service platforms do not consider relationship among vehicle drivers, passengers, and trip sponsors. Moreover, such platforms lack functions such as application approval, automatic departure and arrival verification against trip plans, and centralized management for the company.

### SUMMARY

Various embodiments of the present disclosure can include systems, methods, and non-transitory computer readable media configured to monitor vehicle usage. According to one aspect, a method for monitoring vehicle usage implementable by a server may comprise: obtaining information of one or more vehicles available to provide transportation and one or more transportation requests; matching one or more of the transportation requests with one of the vehicles to determine a planned transportation; determining a first reward to a first user associated with the matched vehicle and a second reward to one or more second users associated with the matched transportation requests; obtaining tracking data of the matched vehicle to determine whether the matched vehicle has started and ended a transportation in compliance with the planned transportation; and in response to determining that the matched vehicle has started and ended the transportation in compliance with the planned transportation, transferring the first reward to the first user and transferring the second reward to the one or more second users.

According to another aspect, a method for monitoring vehicle usage implementable by a computing device of a first user may comprise: transmitting information of a vehicle for providing transportation to a server for determining a planned transportation; determining whether the vehicle has started and ended the transportation in compliance with the planned transportation; and obtaining a first reward, if the vehicle has started and ended the transportation in compliance with the planned transportation.

According to another aspect, a method for monitoring vehicle usage implementable by a computing device of a second user may comprise: transmitting a transportation request to a server for determining a planned transportation in a vehicle, where the planned transportation comprises a portion for transporting the second user; determining whether the vehicle has started and ended the portion of the planned transportation in compliance with the planned transportation; and obtaining a second reward, if the vehicle has started and ended the portion of the planned transportation in compliance with the planned transportation.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an exemplary environment for monitoring vehicle usage, in accordance with various embodiments.

FIG. 2A illustrates an exemplary system for monitoring vehicle usage, in accordance with various embodiments.

FIG. 2B illustrates another exemplary system for monitoring vehicle usage, in accordance with various embodiments.

FIG. 3A-3J illustrate exemplary interfaces of an application for monitoring vehicle usage, in accordance with various embodiments.

FIG. 4A illustrates a flowchart of an exemplary method for monitoring vehicle usage, in accordance with various embodiments.

FIG. 4B illustrates a flowchart of another exemplary method for monitoring vehicle usage, in accordance with various embodiments.

FIG. 4C illustrates a flowchart of another exemplary method for monitoring vehicle usage, in accordance with various embodiments.

FIG. 4D illustrates a flowchart of another exemplary method for monitoring vehicle usage, in accordance with various embodiments.

FIG. 4E illustrates a flowchart of another exemplary method for monitoring vehicle usage, in accordance with various embodiments.

FIG. 4F illustrates a flowchart of another exemplary method for monitoring vehicle usage, in accordance with various embodiments.

FIG. 5 illustrates a block diagram of an exemplary computer system in which any of the embodiments described herein may be implemented.

### DETAILED DESCRIPTION

In current technologies, vehicle services can be provided by private vehicle owners acting as drivers to serve users who request the services from applications. The passengers have to pay the driver for the transportation services. And often, the drivers have no relationship with their passengers outside the scope of the transportation services.

In many other situations, vehicle service providers and vehicle service benefiters have pre-existing relationships, where the traditional model no longer applies. For example, an employee may drive a personal vehicle to perform business activities on behalf of her employer. For another example, several employees of the same company may carpool in one of the employees' personal vehicle at the end an overtime workday to get home. In these situations, vehicle service benefiters such as the employer or the company need a systematic solution to manage applications for such non-personal uses of private vehicles, track the vehicle uses to verify the compliance with approved travel plans, and issue appropriate rewards to the vehicle contributors. However, none of these requirements has been adequately addressed by existing technologies.

The disclosed systems and methods can at least mitigate the above-described disadvantages of current technologies. Various embodiments of the present disclosure include systems, methods, and non-transitory computer readable media configured to monitor vehicle usage. In some embodiments, a vehicle owner associated with an entity may use her private (or a different ownership-type) vehicle for a purpose benefiting the entity. The private vehicle may be used to transport the vehicle owner and/or one or more other users associated with the entity. The vehicle owner, the other users, and the entity may interact via software applications installed on computing devices such as personal mobile phones. Via the application, transportation plans including time, route, and reward budget can be determined and approved. During the transportation, the vehicle owner's and/or the one or more other users' mobile phones may be tracked to verify their compliance with the approved plan. Once the transportation has been completed in accordance with the approved plan, the predetermined reward can be issued to the vehicle owner and/or the one or more other users. As such, entities can effectively manage private vehicle compensation programs. Assembled in a centralized system, application approval, budget control, vehicle usage monitoring, and reward transfer can be achieved in a streamlined fashion, with a vast reduction in the operation cost, increase of work efficiency, and enhancement of employee morale.

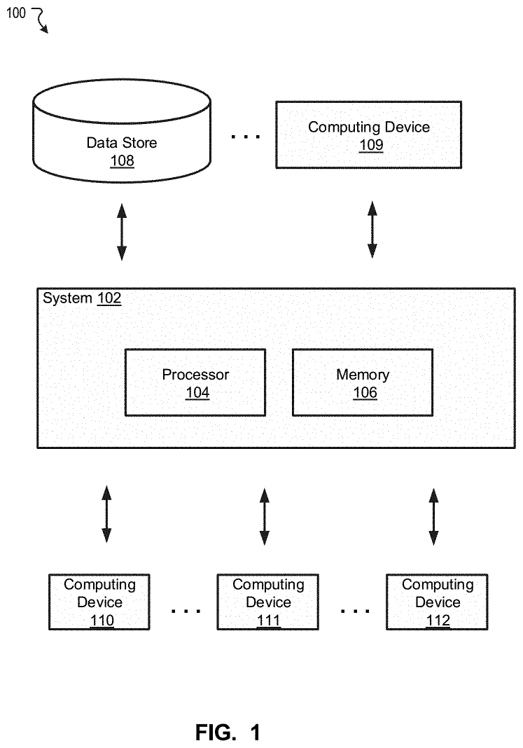

FIG. 1 illustrates an exemplary environment 100 for monitoring vehicle usage, in accordance with various embodiments. As shown in FIG. 1, the exemplary environment 100 can comprise at least one computing system 102 that includes one or more processors 104 and memory 106. The memory 106 may be non-transitory and computer-readable. The memory 106 may store instructions that, when executed by the one or more processors 104, cause the one or more processors 104 to perform various operations described herein. The system 102 may be implemented on or as various devices such as mobile phone, tablet, server, computer, wearable device (smart watch), etc. The system 102 above may be installed with appropriate software and/or hardware (e.g., wires, wireless connections, etc.) to access other devices of the environment 100.

The environment 100 may include one or more data stores (e.g., a data store 108) and one or more computing devices (e.g., a computing device 109) that are accessible to the system 102. In some embodiments, the system 102 may be configured to obtain data (e.g., map data, user data) from or store data into the data store 108 (e.g., dataset of registered users, map database) and/or the computing device 109 (e.g., computer, server, mobile phone used by a user).

The environment 100 may further include one or more computing devices (e.g., computing devices 110, 111, and 112) coupled to the system 102. The computing devices may comprise devices such as mobile phone, tablet, computer, wearable device (smart watch), etc. The computing devices may transmit data to or receive data from the system 102. The transmitted data may comprise user profile data, time data, location data, etc. The location data may comprise GPS (Global Positioning System) coordinates.

In some embodiments, the system 102 may implement an online information or service platform (e.g., in the form of a software application described herein). The service may be associated with vehicles (e.g., cars, bikes, boats, airplanes, etc.). In some embodiments, the platform may accept an application for non-personal use of a private vehicle, approve or reject the application, and track activities of the private vehicle for verification. The platform may also determine a reward to the applicant. In some embodiments, the platform may further accept requests for sharing transportation (before or after the application is approved) and match one or more of the requests to the applicant's vehicle. The platform may verify that the shared transportation has been completed compliantly and reward the applicant and the requestors accordingly.

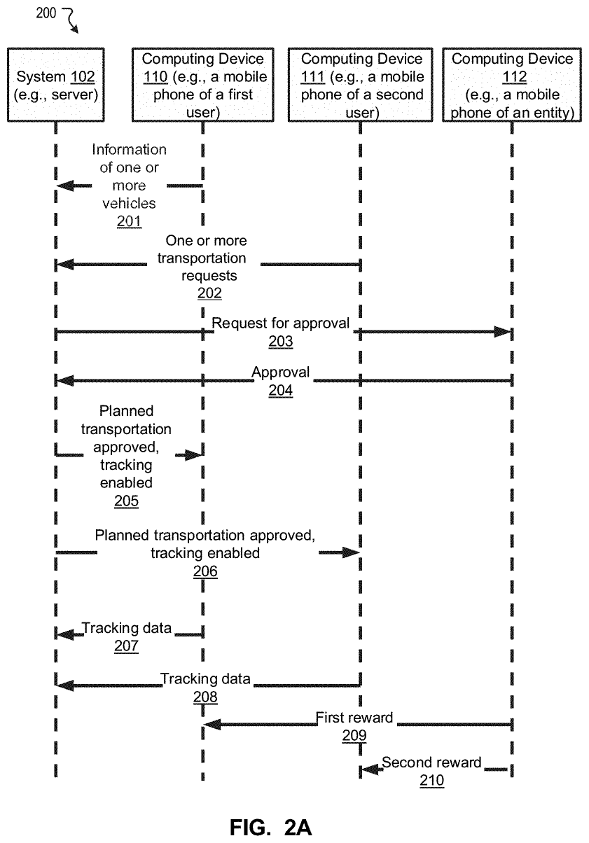

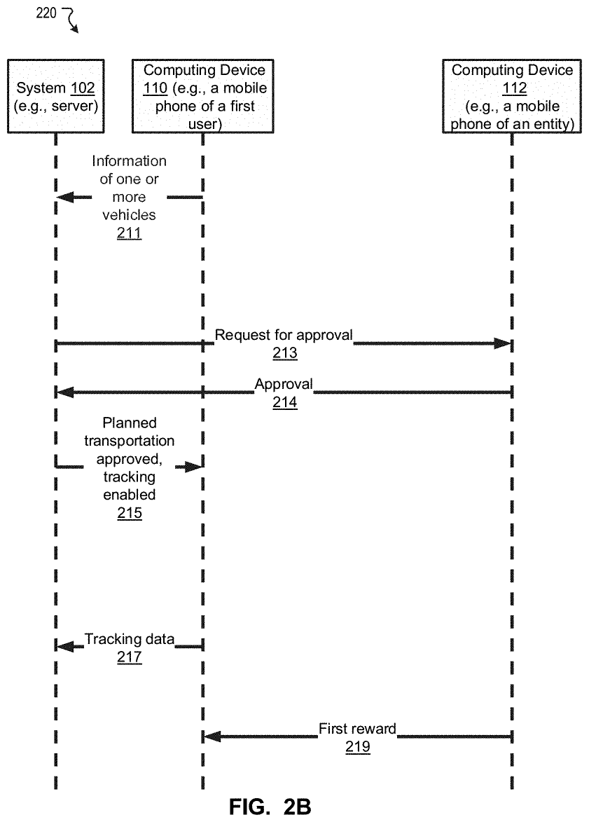

In some embodiments, the system 102 and the one or more of the computing devices (e.g., the computing device 109) may be integrated in a single device or system. Alternatively, the system 102 and the one or more computing devices may operate as separate devices. The data store(s) may be anywhere accessible to the system 102, for example, in the memory 106, in the computing device 109, in another device (e.g., network storage device) coupled to the system 102, or another storage location (e.g., cloud-based storage system, network file system, etc.), etc. Although the system 102 and the computing device 109 are shown as single components in this figure, it is appreciated that the system 102 and the computing device 109 can be implemented as single devices or multiple devices coupled together. The system 102 may be implemented as a single system or multiple systems coupled to each other. In general, the system 102, the computing device 109, the data store 108, and the computing device 110, 111, and 112 are able to communicate with one another through one or more wired or wireless networks (e.g., the Internet) through which data is communicated. Various aspects of the environment 100 are described below in reference to FIG. 2A to FIG. 5.

FIG. 2A illustrates an exemplary system 200 for monitoring vehicle usage, in accordance with various embodiments. The operations shown in FIG. 2A and presented below with respect to the system 200 are intended to be illustrative. Depending on the implementation, the operations shown in FIG. 2A and presented below may include additional, fewer, or alternative steps performed in various orders or in parallel.

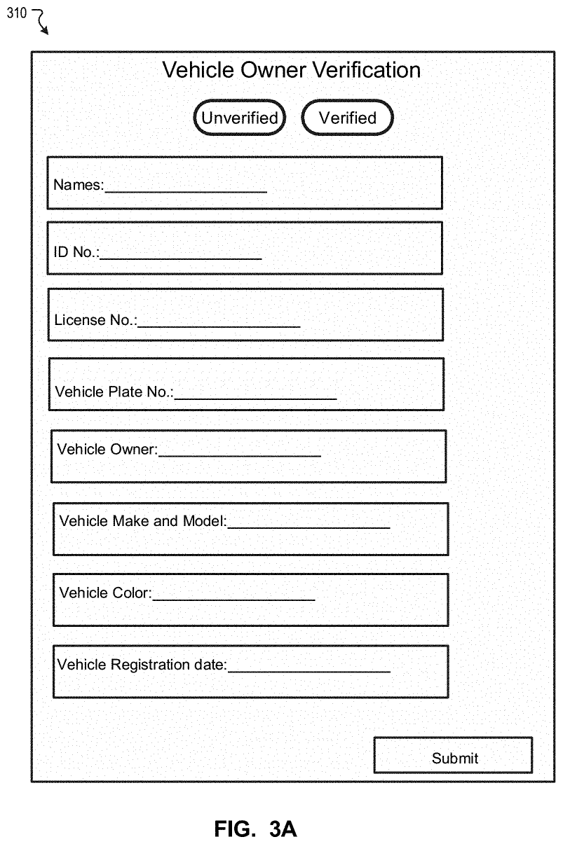

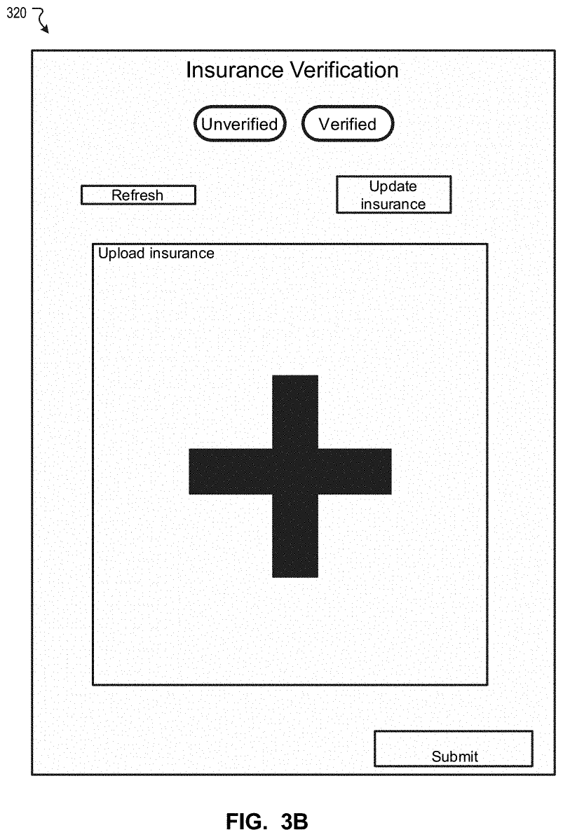

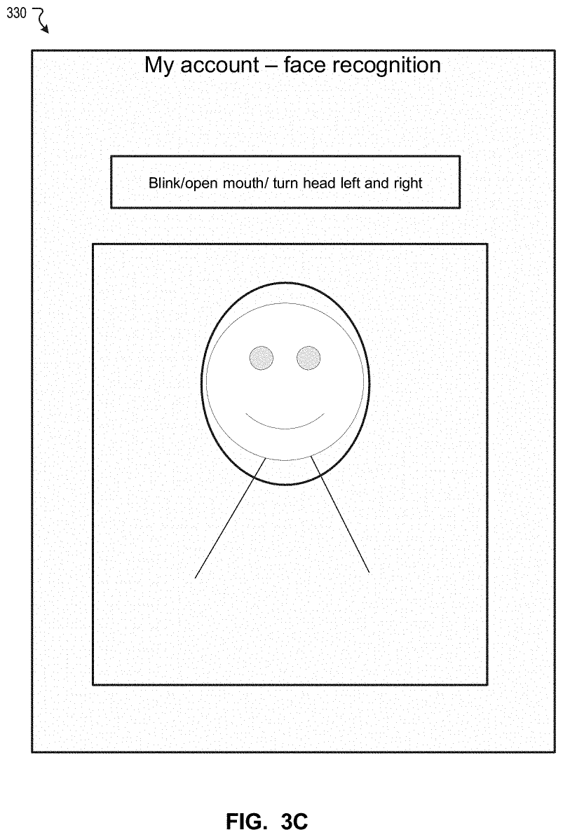

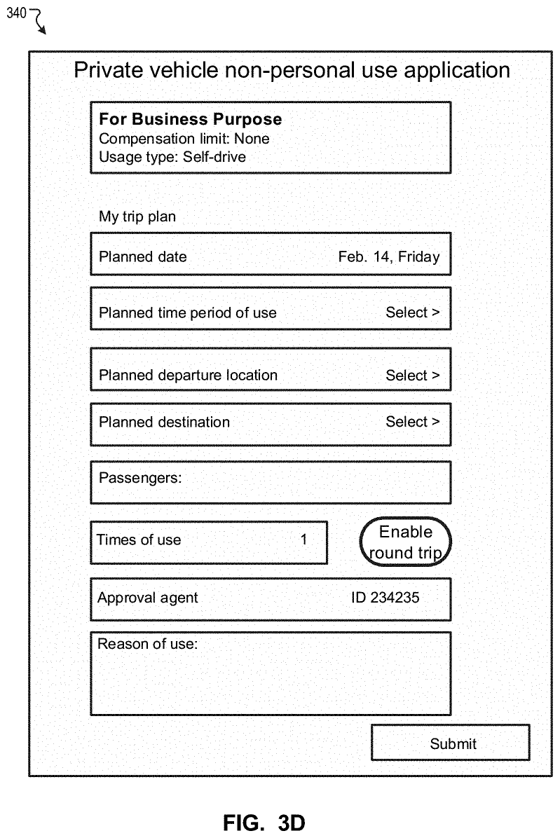

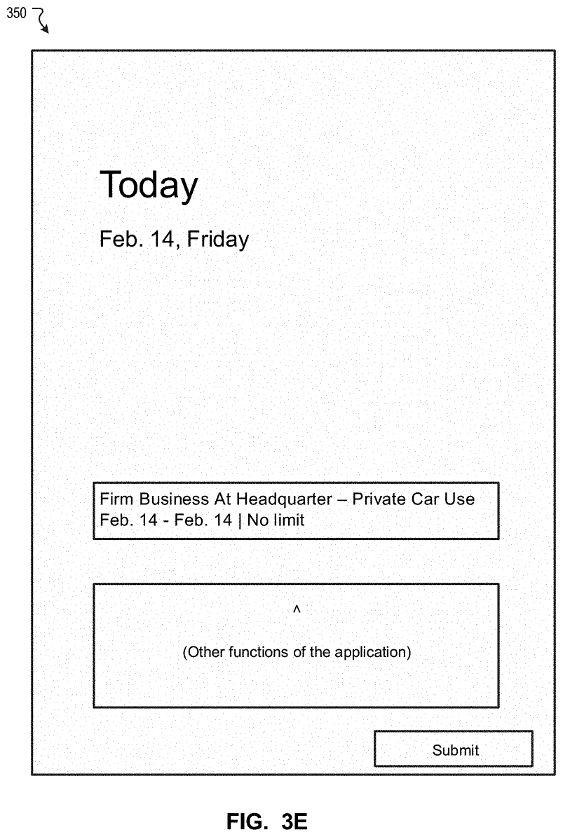

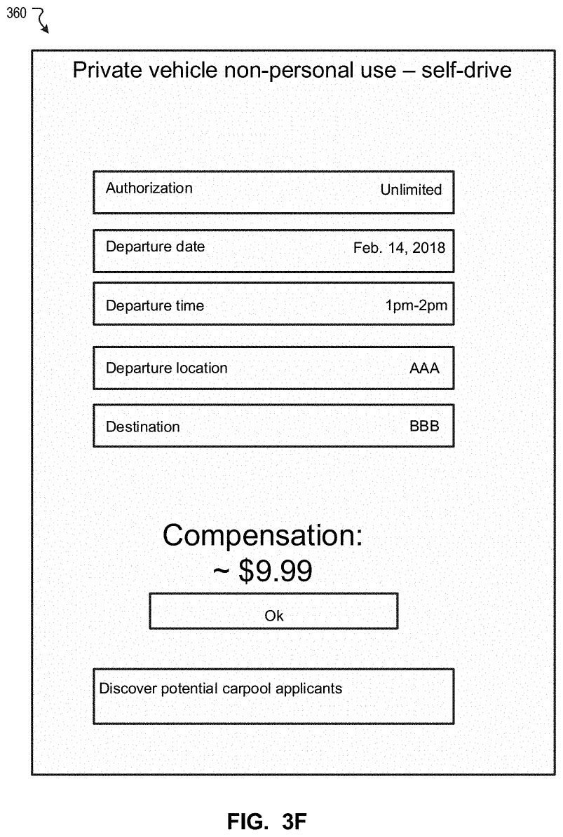

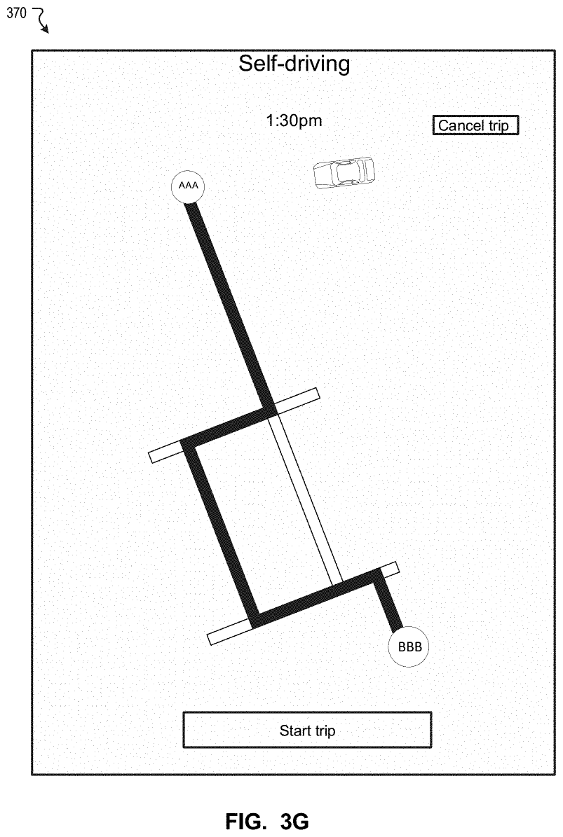

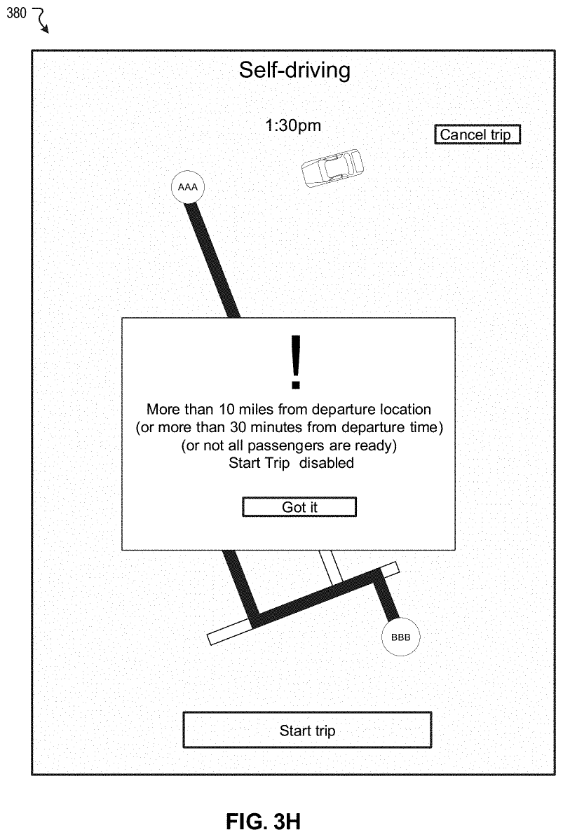

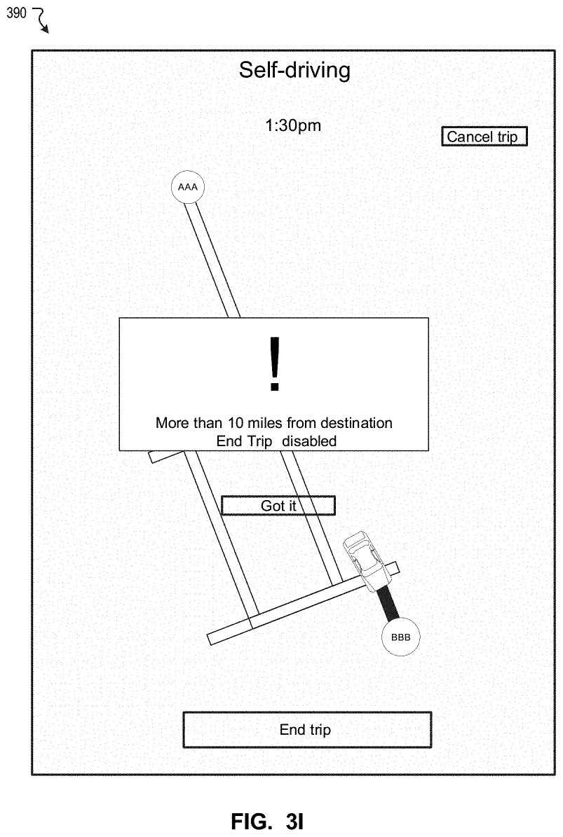

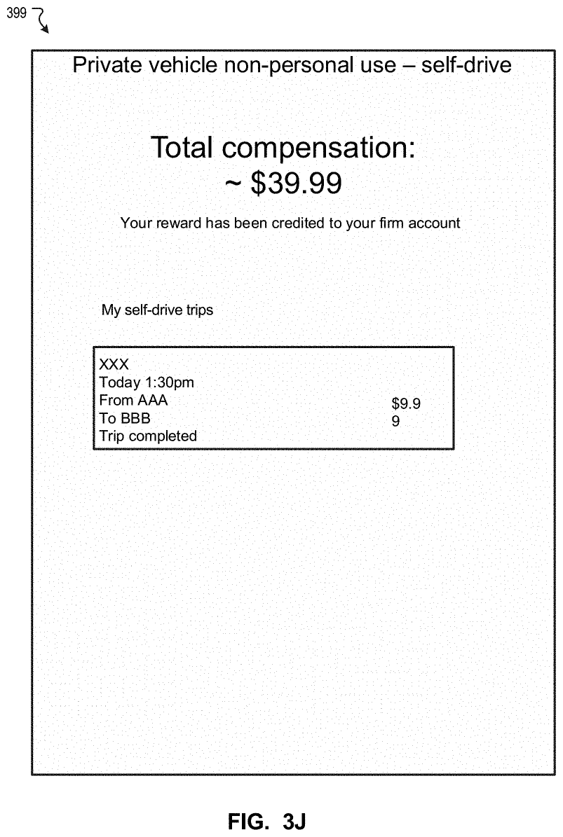

The system 200 may be similar to the system 100 described above, and may comprise a system 102 (e.g., a server), a computing device 110 (e.g., a mobile phone used by a first user), a computing device 111 (e.g., a mobile phone used by a second user), and a computing device 112 (e.g., a mobile phone used by a manager). The first user, the second user, and the manager may all be associated with an entity. In some embodiments, the entity may refer to one or more organizations or companies. For example, the entity may refer to an organization. For another example, the entity may refer to a group of companies, which may run a joint program to compensate non-private use of personal vehicles. That is, employees of the group of companies may be treated as employees of the same entity for this joint program and the vehicle usage monitoring methods described herein. In some embodiments, the three computing devices may each be installed with a software application, which can be executed to obtain inputs (e.g., transportation plan, tracking data) and render outputs (e.g., approval message, reward transaction information). The application installed on the computing device 110 and 111 may render exemplary user-end interfaces described below with reference to FIG. 3A to FIG. 3J. The application installed on the computing device 112 may render corporate-end interfaces with transportation plan approval features and other configuration features as described below.

As discussed above, the each computing device may comprise many other devices than mobile phones. In some embodiments, the computing device 112 may be incorporated into the system 102 and the steps performed by the computing 112 may be implemented by the system 102.

In various embodiments, the system 102 may obtain (1) information 201 of one or more vehicles available to provide transportation from the computing device 110 and (2) one or more transportation requests 202 from the computing device 111. The system 102 may obtain one or more pieces of vehicle information 201 and one or more transportation requests 202 from one or more computing devices in any order. For example, the system 102 may collect vehicle information 201 and transportation requests 202 internally within an entity (e.g., only from employees of a company). Each piece of vehicle information 201 may be associated with a private vehicle of an employee, and may include the name of the employee owner, the color of the vehicle, the make and model of the vehicle, the plate number of the vehicle, available passenger seats, etc. The vehicle information 201 may further include details of a planned use of the private vehicle, such as a planned trip from location A to location B at time C to conduct business for the company, a plan ride from company to home residence after overtime work, etc. In one example, the vehicle information 201 may include a planned departure time, a planned departure location, and/or a planned destination for the planned use of the private vehicle. At this stage, this planned use of the private vehicle may only involve first user and may not involve any second user yet. Alternatively, the first user may already find one or more second users to share the ride, and may submit information of all of the passengers for the ride.

In some embodiments, the system 102 may further obtain the vehicle information 201 and the transportation requests 202, and match one or more of the transportation requests with one of the vehicles to determine a planned transportation. The system 102 may perform the match based on rules such as optimizing trip time, trip distance, trip budget, etc. Thus, second users looking for shared rides can be respectively matched with first users willing to share their vehicles for the rides. For each of the planned transportation, the system 102 may also determine a first reward to a first user associated with the matched vehicle (e.g., first users being owners and drivers of the vehicles) and a second reward to one or more second users associated with the matched transportation requests (e.g., second users being hitchhikers). The each reward may be determined based on a current price for hiring taxi or another service vehicle to carry out the transportation. For example, the first reward can be 50% of the price for hiring a service vehicle, and the second reward can be 70% of the price for hiring a service vehicle. In some embodiments, the computing device 112 may configure the reward determinization (e.g., as a percentage of a current price for hiring a service vehicle for an equivalent ride), and opt not to review the reward when approving planned transportation. Alternatively, the computing device 112 may set an upper limit of the reward (e.g., for each trip, for a configurable time period, for a configurable geographic region). Alternatively, the computing device 112 may opt to review the with each application for planned transportation and optionally make further adjustments.

Optionally, the system 102 may provide information of the planned transportation to the entity for approval, the information of the planned transportation including at least one of: the matched vehicle, the matched transportation requests, the first user, the one or more second users, the first reward, or the second reward. For example, the system 102 may transmit a request for approval 203 to the computing device 112 for approval.

In some embodiments, once an approval 204 is received from the computing device 112, the system 102 may notify the first and/or second users through their respective computing devices that the planned transportation has been approved at step 205 and step 206. The computing device 112 may also directly transmit the approval 204 to the computing devices 110 and 111. The approved budget (e.g., the first reward and the second reward) may be shown to the first and second users respectively. Also, the system 102 may enable obtaining tracking data from the computing devices 110 and/or 111 only if the planned transportation is approved. With the approval, the applications respectively installed on the computing devices 110 and 111 are enabled to track the corresponding computing devices to verify starting and ending the transportation in compliance with the approved plan.

In some embodiments, if no approval is required, the planned transportation used for tracking and trip verification may include the planned departure time, the planned departure location, and/or the planned destination as submitted. In some embodiments, if the approval is required, the planned transportation used for tracking and trip verification may include the planned departure time, the planned departure location, and/or the planned destination as submitted or as amended, as long as the entity approves.

In some embodiments, the vehicles (including the matched vehicles) are private properties of the first users respectively. The first user and the one or more second users are affiliated with an entity. For example, the first user and the second user work in the same company, and the company as the entity uses the above-described software application to monitor vehicle usage to compensate employees who contribute their personal vehicles for the company's course. That is, the planned transportation is at least in part to the entity's benefit.

In some embodiments, alternatively, the transportation requests 202 may be obtained at a later step than that shown in FIG. 2A and before tracking data 207 is obtained. For example, after the first user's transportation plan for transporting the first user is approved (that is, approval 204 is received), the first user may use the computing device 110 to find one or more second users seeking for a ride that can be covered under the first user's approved transportation plan. Thus, the first user can pool the one or more second users into her transportation plan and notify the system 102. The system 102 may refine the approved transportation plan, for example, by adding pick-up and drop-off locations, increasing the first reward based on the addition of passengers, determining the second reward for the each second user, etc.

Regardless when the second user(s) joins the transportation plan, the following steps may be carried out similarly. In some embodiments, the system 102 may obtain tracking data of the matched vehicle to determine whether the matched vehicle has started and ended a transportation in compliance with the planned transportation. The tracking data of the matched vehicle may comprise tracking data 207. The tracking data 207 may be transmitted from the computing device 110 to the system 102. The tracking data 207 may comprise a location of the computing device 110 with respect to time. The location of the computing device 110 may be associated with a location of the matched vehicle. For example, the first user and the one or more second users are in the vehicle during at least a segment of the transportation. When the first user is inside the matched vehicle during the planned transportation, the location of the computing device 110 can be treated as the location of the vehicle, thereby achieving tracking of the vehicle. The tracked location of the vehicle can be compared with various predetermined locations to verify the compliance with the approved plan. Additionally, if the transportation plan includes a second user, the tracking data 208 may be transmitted from the computing device 111 to the system 102. The tracking data 208 may comprise a location of the computing device 111 with respect to time. A proximity of the location of the computing device 110 and the location of the computing device 111, as well as matching moving speed patterns of the two computing devices, can help verify that the first user and the second user ride in the same vehicle.

In some embodiments, in response to determining that the matched vehicle has started and ended the transportation in compliance with the planned transportation (assuming that the obtained information 201 has become the approved transportation plan), the system 102 and/or the computing device 112 may transfer the first reward 209 to the first user and transfer the second reward 210 to the one or more second users. For example, the first reward 209 and the second reward 210 may be issued as credits or alternative forms to the first user's and the second user's accounts.

Various methods can be used by the system 102 to determine the planned transportation and accordingly verify the implementation of the planned transportation. In some embodiments, the system 102 may receive initial inputs by the first and second users respectively included in the vehicle information 201 and the transportation request 202. Accordingly, the system 102 may determine details of the planned transportation based on optimizing factors such as trip time, trip distance, and/or trip budget. For example, the first user may input her planned departure time, departure location, and destination based on her agenda alone. The system 102 may determine the planned transportation by incorporating the first user's inputs, and the second user may agree to such arrangement to share the vehicle for the ride. Alternatively, the system 102 may update the first user's initial inputs based on the second user's inputs (e.g., a planned pick-up location and a planned drop-off location) to obtain the planned transportation. For example, based on the optimization, the system 102 may change the first user's planned departure time to an earlier or later time, or add a drop-off location along the first user's planned route to drop off the second user.

In some embodiments, the system 102 may pool a first user and/or one or more second users into one planned transportation. For example, if a user A (first user) plans to drive her car to a bank to conduct company business, user B and user C (both second users) live near the bank and each seek for a ride back, and all of the them indicate a similar departure time, the system 102 may pool users A, B, and C into a planned transportation.

In some embodiments, determining the planned transportation may comprise: determining a planned departure time for the planned transportation, a planned departure location for the planned transportation, and/or a planned destination for the planned transportation. Assuming that the planned transportation determined by the system 102 is accepted by the first and second users, the planned departure time for the planned transportation, the planned departure location for the planned transportation, and/or the planned destination for the planned transportation may be used to compare with tracking data of the computing devices 110 and 111 to verify whether the transportation has been carried out in compliance with the approved plan as discussed below. The verification can help prevent defrauding rewards with unapproved vehicle uses.

In some embodiments, obtaining the tracking data of the matched vehicle to determine whether the matched vehicle has started and ended the transportation in compliance with the planned transportation comprises: obtaining at least one of a first current time of the vehicle or a first current location of the vehicle, to determine if the vehicle has started the transportation based on at least one of: comparing the planned departure time with the first current time, or comparing the planned departure location with the first current location; and obtaining a second current location of the vehicle, to determine if the vehicle has ended the transportation based on comparing the planned destination with the second current location. For example, as the first and the second users are ready in a vehicle to start a transportation, the first user may use the computing device 110 to trigger a request A to verify the transportation can be commenced in compliance with the planned transportation. The first user may trigger the request from the installed application, transmitting the request A to the system 102. In response, the system 102 may obtain the computing device 110's current location as the vehicle's current location and compare the vehicle's current location with the planned departure location for verification. Alternatively, the computing device 110 may obtain the planned departure location for the first user and compare the planned departure location with the current location of itself and transmit the comparison result to the system 102. Additionally, if one or more second users share the ride, the system 102 may obtain the computing device 111's current location as the second user's current location for comparison. Alternatively, the computing device 111 may obtain the planned departure location for the second user and compare the planned departure location with the current location of itself and transmit the comparison result to the system 102.

Similarly, when the vehicle has reached the destination, the first user may use the computing device 110 to trigger a request B to verify the end of the planned transportation. The first user may trigger the request from the installed application, transmitting the request B to the system 102. In response, the system 102 may obtain the computing device 110's current location as the vehicle's current location for comparison. In response, the system 102 may obtain the computing device 110's current location as the vehicle's current location and compare the vehicle's current location with the planned destination for verification. Alternatively, the computing device 110 may obtain the planned destination for the first user and compare the planned destination with the current location of itself and transmit the comparison result to the system 102. Additionally, if one or more second users share the ride, the system 102 may obtain the computing device 111's current location as the second user's current location for comparison. Alternatively, the computing device 111 may obtain the planned destination for the second user and compare the planned destination with the current location of itself and transmit the comparison result to the system 102.

In some embodiments, obtaining the first current time comprises: in response to receiving an indication (e.g., the request A) of starting the transportation from a computing device associated with the first user, obtaining the first current time; obtaining the first current location of the vehicle comprises: in response to receiving the indication of starting the transportation from the computing device, obtaining a first current location of the computing device as the first current location of the vehicle; and obtaining the second current location of the vehicle comprises: in response to receiving an indication (e.g., the request B) of ending the transportation from the computing device, obtaining a second current location of the computing device as the second current location of the vehicle. Similarly, if a second user is sharing the ride with the first user, the second user may send indications respectively when being picked up and dropped off. Accordingly, the locations of the computing device of the second user can be obtained (e.g., by the system 102) to verify against the approved pick-up and drop-off locations previously submitted by the second user.

In some embodiments, comparing the planned departure time with the first current time comprises: comparing a time difference between the planned departure time and the first current time with a time threshold (e.g., a time threshold configured by the computing device 112). In some embodiments, comparing the planned departure location with the first current location comprises: comparing a first geographic distance between the planned departure location and the first current location (e.g., a current location of the vehicle when the vehicle drive triggers the application to verify the start of the planned transportation) with a first distance threshold (e.g., a first distance threshold configured by the computing device 112). In some embodiments, comparing the planned destination with the second current location comprises: comparing a second geographic distance between the planned destination and the second current location (e.g., a current location of the vehicle when the vehicle drive triggers the application to verify the end of the planned transportation) with a second distance threshold (e.g., a second distance threshold configured by the computing device 112). If the driver requests verification when within limitations imposed the corresponding thresholds (the time threshold, distances threshold, and/or any other defined thresholds), the driver can be verified to have started and ended the transportation compliantly. These limitations can help ensure that the vehicle use is carried out as approved and within a tolerable range of deviation, such that mistaken use can be prevented and unapproved uses can be differentiated. The system 102 and/or the computing device 112 can determine which limitations to impose for screening the unapproved uses.

In some embodiments, the system 102 may: in response to at least one of the time difference exceeding the time threshold or the first geographic distance exceeding the first distance threshold, cause the computing device (e.g., the computing device 110) to render a notification that the planned transportation has not started; and in response to the second geographic distance exceeding the second distance threshold, cause the computing device to render a notification that the planned transportation has not ended. Thus, the notification can help the driver to comply with the approved plan to avoid losing the rewards. Noncompliance with the plan can cause the users to lose their rewards.

FIG. 2B illustrates an exemplary system 220 for monitoring vehicle usage, in accordance with various embodiments. The operations shown in FIG. 2B and presented below with respect to the system 220 are intended to be illustrative. Depending on the implementation, the operations shown in FIG. 2B and presented below may include additional, fewer, or alternative steps performed in various orders or in parallel.

The system 220 and associated steps may be similar to those described above with respect to the system 200, except for the omission of the computing device 111 and related steps. While FIG. 2A may illustrate situations where one or more second users share the vehicle with the first user, FIG. 2B may illustrate situations where no other user share the vehicle with the first user and only the first user is rewarded. For example, the system 102 may obtain vehicle information 211 (similar to the vehicle information 201) from the computing device 110. The system 102 may transmit a request for approval 213 (similar to the request for approval 203) to the computing device 112. The computing device may transmit an approval 214 (similar to the approval 204) to the system 102. The system 102 may transmit an approval of the planned transportation to the computing device 110 and enable tracking for verifying starting or ending the transportation at step 215 (similar to the step 205). The computing device 110 may transmit tracking data 217 (similar to tracking data 207) to the system 102. The system 102 and/or the computing device 112 may transfer the first reward 219 (similar to the first reward 209) to the first user.

FIGS. 3A-3J illustrate exemplary interfaces of an application for monitoring vehicle usage, in accordance with various embodiments. The exemplary interfaces may be implemented on the computing device 110 and/or computing device 111. The operations shown in FIGS. 3A-3J and presented below are intended to be illustrative.

As shown in FIG. 3A, an interface 310 may provide options for the user (e.g., the first user) to register her vehicle with the system 102. The user may be prompted to provide information of her name, ID, license, vehicle plate, vehicle owner, vehicle make and model, vehicle color, vehicle registration date, etc. The provided information may be comprised in the vehicle information 201 (or 211). The system 102 may verify the provided information. The verification can be performed manually or automatically against ground truth information (e.g., by executing a machine learning algorithm). The interface 310 may show an indication whether the provided information has been verified. In some embodiments, if the entity does not maintain a database of its associates, the interface 310 can further prompt the applicant to identify her relationship with the entity (e.g., employee-employer relationship). The applicant may be prompted to enter an identification associated with the entity. Accordingly, the entity can verify the identity of the applicant, and only allow its associates to submit planned transportation applications. In some embodiments, if the entity maintains a database of its associates, the entity can compare the applicant's biographical information with stored biographical information of its associates, and only allow its associates to submit planned transportation applications. In some embodiments, the entity can assign authorization levels to the applicants. For example, associates of the entity can be assigned authorization levels of 1 to 5 depending on her rank, and public users can be assigned an authorization level of 0. From the corporate-end interface, the entity can limit various user-end application functionalities to users of certain authorization levels.

As shown in FIG. 3B, an interface 320 may provide options for the user (e.g., the first user) to upload her vehicle insurance. The user may upload an image of the insurance for verification. The interface 320 may show indication whether the uploaded insurance has been verified. The user can also refresh or update the uploaded insurance. The verification can be performed manually or automatically against verified information (e.g., by executing an image recognition algorithm).

As shown in FIG. 3C, an interface 330 may provide options for the user (e.g., the first user) to upload face image for face recognition. The interface 330 may trigger a camera on the computing device to capture face images. The interface 330 may prompt the user to pose for the capture (e.g., blink, open mouth, turn head left and right, etc.). The capture may comprise photos and/or short clips (e.g., a continuous capture while the user is posing). Once the face images are captured, the system 102 may obtain facial traits from the capture and associate the user's identity with facial traits. Next time when a person uses a computing device to perform actions related to the user (e.g., starting a planned transportation), the system 102 may prompt to verify identity by face image capture.

As shown in FIG. 3D, an interface 340 may provide options for the user (e.g., the first user) to apply for non-personal use of the user's private vehicle. The interface 340 may indicate that the applied use is “for business purpose,” the compensation limit is “none,” and the usage type is “self-drive.” These settings can be configured by the computing device 112. The user may be prompted to provide a “trip plan,” such as planned date for the trip, planned time period of use, planned departure location, planned destination, passengers, times of use, reason of use, available seats for sharing (not shown in the figure), etc. The provided information may be comprised in the vehicle information 201 (or 211). In some embodiments, a similar version of the interface 340 (without the passengers, times of use, and available seats for sharing) may be provided to the second users who do not have vehicles registered with the system 102 to obtain the transportation requests 202 (or 212). With the vehicle information 201 (or 211) and the transportation requests 202 (or 212), the system 102 may perform the matching and approval processes as discussed above.

As shown in FIG. 3E, once the planned transportation has been approved, an interface 350 may render the approved transportation, for example, at the front page of the application. The rendering may include a reminder of the transportation, for example “firm business at headquarter—private car use Feb. 14-Feb. 14|No limit.” A user may trigger rendering to bring up details of the approved trip, such an interface 360 described below.

As shown in FIG. 3F, the user may confirm the planned transportation, for example by triggering an associated command from an interface 360. On the interface 360, approved details of the planned transportation such as the authorization (e.g., unlimited), the planned date (e.g., Feb. 14, 2018), the planned departure time (e.g., 1 pm-2 pm), the planned departure location (e.g., AAA), the planned destination (e.g., BBB), and first reward (e.g., $9.99) can be shown. The authorization may be determined by the system 102 and/or the computing device 112 and be associated with the user. For example, a higher-rank employee may have a higher authorization level, and a public member outside the entity may have the lowest authorization level. As discussed earlier, the first user as the vehicle owner or driver may be matched by the system 102 with one or more second users who want to share the ride, and the system 102 may determine the planned transportation for the matched first and second users. Alternatively, one or more second users can join the first use whose planned transportation has been determined by the system 102 and been approved. For example, the first user may discover potential carpool users by triggering a corresponding command on the interface 360 to browse ride-seeking second users. The first user may pick one or more of the second users who will accordingly receive notifications via their applications and may accept the ride-sharing invitation by the first user.

As shown in FIG. 3G, on an interface 370, a first user (e.g., as the driver) may indicate an onset of the planned transportation by pressing “start trip,” which may serve as an indication for the system 102 and/or the computing device 110 to verify the compliance with the approved plan. On the interface 370, a current time may also be shown, and a map may be provided with a highlighted route from the planned departure location “AAA” to the planned destination “BBB.” Additionally, the current location of the vehicle (e.g., based on the location of the computing device 110) may be indicated with a vehicle icon, and the vehicle position relative on the map can be updated in real time.

In some embodiments, the current location of the vehicle is too far away from the planned departure location, and the proximity to the planned departure location is required to be verified (e.g., as required by the computing device 112). As shown in FIG. 3H, the computing device 110 may show a warning on an interface 380 and disable starting the planned transportation in the application. An exemplary warning shown in this figure reads “more than 10 miles from departure location” and “‘start trip’ disabled.” The “10 miles” may be a threshold determined by the computing device 112 among various conditions to verify compliance with the approved transportation plan. Similarly, if the current time is too late from the planned departure time, and if the temporal proximity is required, a warning such as “more than 30 minutes from departure time” and “‘start trip’ disabled” may be shown. Similarly, if the presence of all passengers (e.g., a first user and a second user) are required to start the planned transportation, the system 102 may obtain locations of the computing devices 110 and 111 and compare the proximity between the obtained locations with a threshold to determine whether all passengers are in the vehicle. If not, a warning such as “not all passengers are ready” may be shown.

As shown in FIG. 3I, similar to the interface 380, if the current location of the vehicle is too far away from the planned destination, and if the proximity to the planned destination is required to be verified (e.g., as required by the computing device 112), the computing device 110 may show a warning on an interface 390 and disable ending the planned transportation in the application. An exemplary warning shown in this figure reads “more than 10 miles from destination” and “‘end trip’ disabled.” The starting and ending of the transportation in the application can provide bases for issuing or canceling rewards.

As shown in FIG. 3J, if the planned transportation has been completed in compliance with the approved plan, the participating user(s) may each receive a notification summarizing the trip on an interface 399 of the respective computing device. The summary may include the reward received for the completed trip, details of the trip, etc. This notification can signify the issuance of the trip reward(s). A cumulative total reward credited to the user (e.g., “total compensation: $39.99”) may be also shown.

As such, an entity such as a corporation can conveniently manage compensation plans for its associates. Applications installed on computing devices such as mobile phones can help collect private vehicle sharer and user information and match supply and demand based on resource optimization. The Applications can further help track the use of the vehicles to verify the compliance with approved plans and issue rewards for contributing personal vehicles to the entity's benefit. Whereas non-compliant uses can be detected, and proposed rewards can be canceled.

The disclosed systems and methods can empower entities to streamline private vehicle usage management. With a centralized system, an entity can efficiently configure requirements for reimbursing private vehicle usage and manage application approval with a close watch on budget. For example, a trip can be set to be reimbursable only if the trip starts within 10 miles from the approved departure location, starts after 8 pm which is deemed overtime, and/or ends within 10 miles from the approved destination. For another example, the entity can assign authorization levels to users and configure vehicle usage application restrictions for each authorization level (e.g., a lower authorization level may apply only in a restricted time period and a restricted location range, the application is only open to entity associates and closed to public). Thus, the entity can controllably roll out the reimbursement plan and motivate its associates to share transportation, achieving overall conversation of resources.

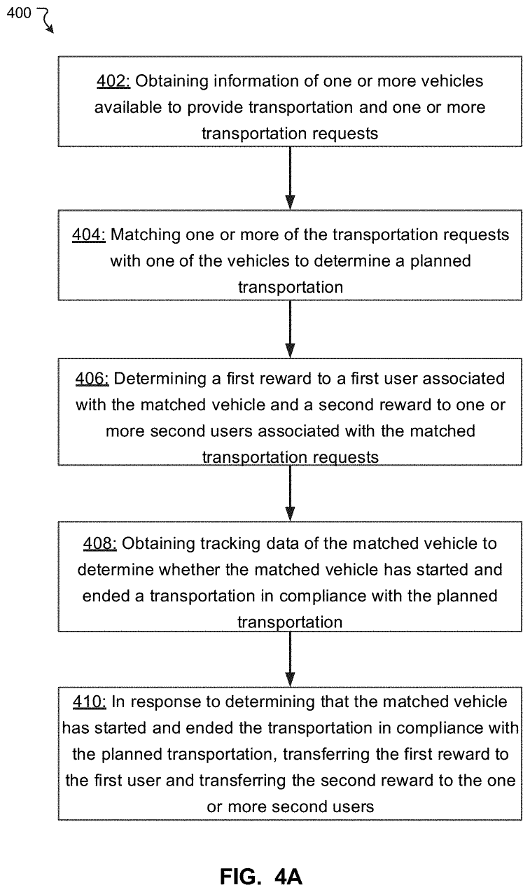

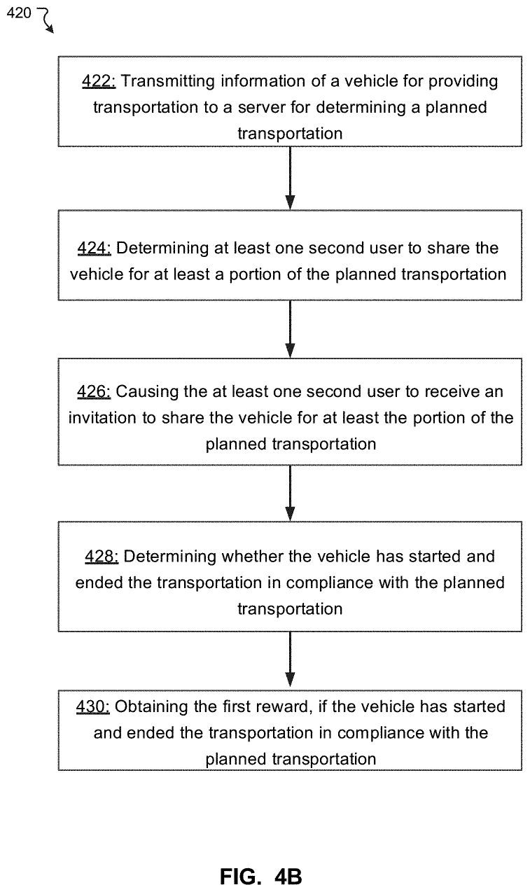

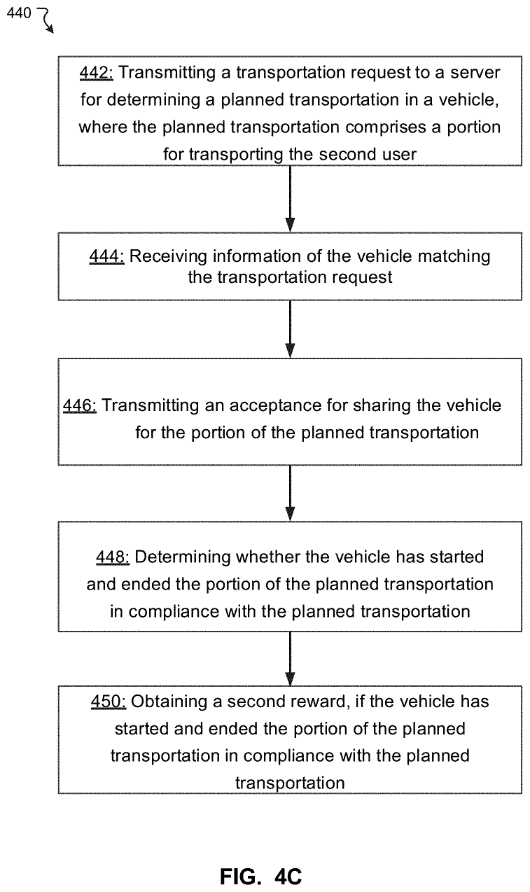

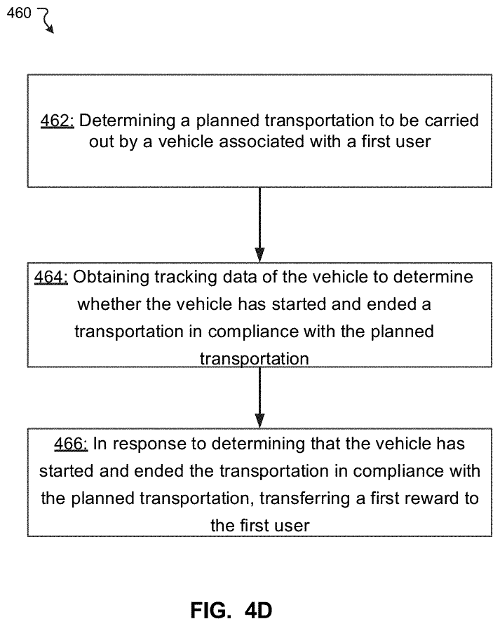

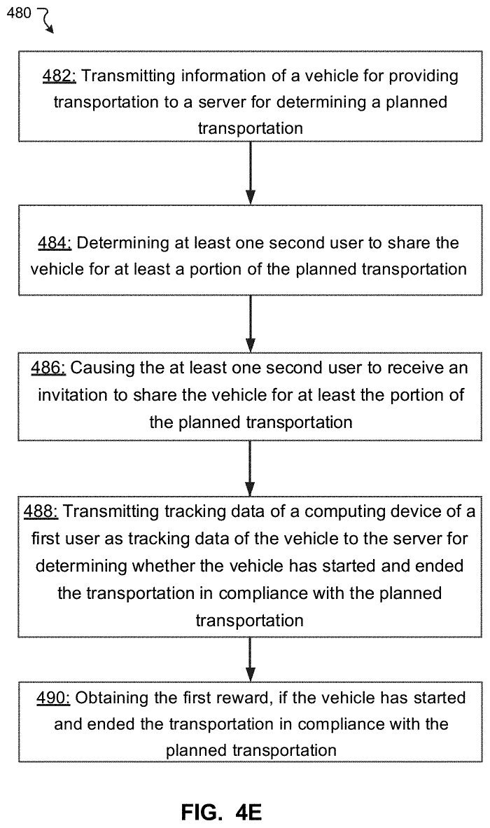

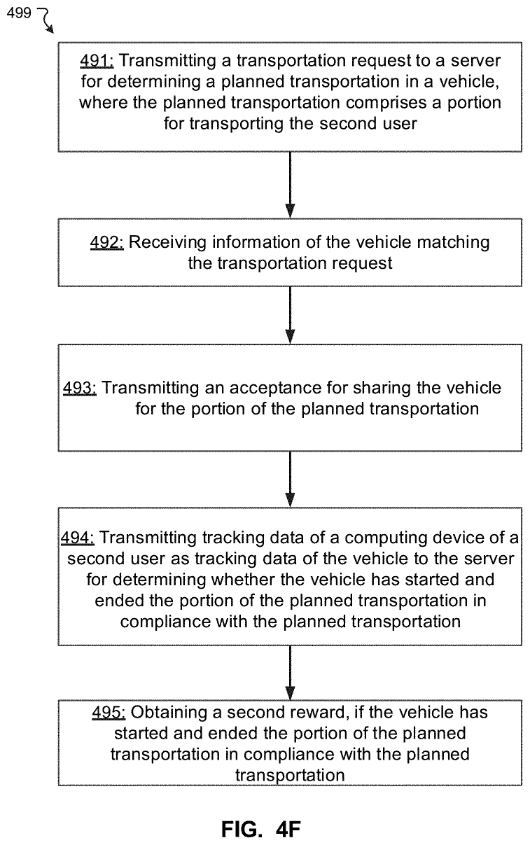

FIG. 4A illustrates a flowchart of an exemplary method 400 for monitoring vehicle usage, according to various embodiments of the present disclosure. The method 400 may be implemented in various environments including, for example, the environment 100 of FIG. 1. The exemplary method 400 may be implemented by one or more components of the system 102 (e.g., the processor 104, the memory 106). An exemplary system 102 may include a server. The exemplary method 400 may be implemented by multiple systems similar to the system 102. The operations of method 400 presented below are intended to be illustrative. Depending on the implementation, the exemplary method 400 may include additional, fewer, or alternative steps performed in various orders or in parallel.

At block 402, information of one or more vehicles available to provide transportation and one or more transportation requests may be obtained. At block 404, one or more of the transportation requests may be matched with one of the vehicles to determine a planned transportation. At block 406, a first reward to a first user associated with the matched vehicle and a second reward to one or more second users associated with the matched transportation requests may be determined. At block 408, tracking data of the matched vehicle may be obtained to determine whether the matched vehicle has started and ended a transportation in compliance with the planned transportation. At block 410, in response to determining that the matched vehicle has started and ended the transportation in compliance with the planned transportation, the first reward may be transferred to the first user, and the second reward may be transferred to the one or more second users. In some embodiments, the obtained information here (e.g., planned departure time, planned departure location, and planned destination) may be approved and included in the planned transportation.

FIG. 4B illustrates a flowchart of an exemplary method 420 for monitoring vehicle usage, according to various embodiments of the present disclosure. The method 420 may be implemented in various environments including, for example, the environment 100 of FIG. 1. The exemplary method 420 may be implemented by the computing device 110 (e.g., a mobile phone of a first user). The operations of method 420 presented below are intended to be illustrative. Depending on the implementation, the exemplary method 420 may include additional, fewer, or alternative steps performed in various orders or in parallel.

At block 422, information of a vehicle for providing transportation may be transmitted to a server for determining a planned transportation. At block 424, optionally, at least one second user may be determined to share the vehicle for at least a portion of the planned transportation, wherein the at least one second user is affiliated with the entity. At block 426, optionally, the at least one second user may be caused to receive an invitation to share the vehicle for at least the portion of the planned transportation. At block 428, whether the vehicle has started and ended the transportation in compliance with the planned transportation may be determined. At block 430, the first reward may be obtained, if the vehicle has started and ended the transportation in compliance with the planned transportation.

In some embodiments, the vehicle is a private property of the first user. The first user is affiliated with an entity. The first user is in the vehicle during at least a segment of the planned transportation. In some embodiments, before the block 428, the determination of whether the vehicle has started and ended the transportation in compliance with the planned transportation may be enabled only after receiving an approval of the planned transportation from the entity.

In some embodiments, determining whether the vehicle has started the transportation in compliance with the planned transportation comprises: obtaining at least one of (1) a planned departure time for the planned transportation and a first current time of the vehicle, or (2) a planned departure location for the planned transportation and a first current location of the vehicle to determine if the vehicle has started the transportation in compliance with the planned transportation. Determining whether the vehicle has ended the transportation in compliance with the planned transportation comprises: obtaining a planned destination for the planned transportation and a second current location of the vehicle to determine if the vehicle has ended the transportation in compliance with the planned transportation.

In some embodiments, determining whether the vehicle has started the transportation in compliance with the planned transportation comprises: obtaining at least one of a first current time of the vehicle or a first current location of the vehicle, transmitting at least one of the first current time of the vehicle or the first current location of the vehicle to the server for determining if the vehicle has started the transportation in compliance with the planned transportation, and receiving from the server the determination of whether the vehicle has started the transportation in compliance with the planned transportation. Determining whether the vehicle has ended the transportation in compliance with the planned transportation comprises: obtaining a second current location of the vehicle, transmitting the second current location of the vehicle to the server for determining if the vehicle has ended the transportation in compliance with the planned transportation, and receiving from the server the determination of whether the vehicle has ended the transportation in compliance with the planned transportation.

FIG. 4C illustrates a flowchart of an exemplary method 440 for monitoring vehicle usage, according to various embodiments of the present disclosure. The method 440 may be implemented in various environments including, for example, the environment 100 of FIG. 1. The exemplary method 440 may be implemented by the computing device 111 (e.g., a mobile phone of a second user). The operations of method 440 presented below are intended to be illustrative. Depending on the implementation, the exemplary method 440 may include additional, fewer, or alternative steps performed in various orders or in parallel.

At block 442, a transportation request may be transmitted to a server for determining a planned transportation in a vehicle, where the planned transportation comprises a portion for transporting the second user. At block 444, optionally, information of the vehicle matching the transportation request may be received (e.g., from the server). At block 446, optionally, an acceptance for sharing the vehicle for the portion of the planned transportation may be transmitted (e.g., to the server, to a computing device of a first user). At block 448, whether the vehicle has started and ended the portion of the planned transportation in compliance with the planned transportation may be determined. At block 450, a second reward may be obtained, if the vehicle has started and ended the portion of the planned transportation in compliance with the planned transportation.

In some embodiments, the vehicle is a private property of a first user. The first user and the second user are affiliated with an entity. The first user and the second user are in the vehicle during the portion of the planned transportation. In some embodiments, before the block 448, the determination of whether the vehicle has completed the portion of the planned transportation in compliance with the planned transportation may be enabled only after receiving an approval of the planned transportation from the entity.

In some embodiments, determining whether the vehicle has started the portion of the planned transportation in compliance with the planned transportation comprises: obtaining a planned departure location for the second user and a third current location of the vehicle to determine if the vehicle has started the portion of the planned transportation in compliance with the planned transportation. Determining whether the vehicle has ended the portion of the planned transportation in compliance with the planned transportation comprises: obtaining a planned destination for the second user and a fourth current location of the vehicle to determine if the vehicle has ended the portion of the planned transportation in compliance with the planned transportation.

In some embodiments, determining whether the vehicle has started the portion of the planned transportation in compliance with the planned transportation comprises: obtaining a third current location of the vehicle, transmitting the third current location of the vehicle to the server for determining if the vehicle has started the portion of the planned transportation in compliance with the planned transportation, and receiving from the server the determination of whether the vehicle has started the portion of the planned transportation in compliance with the planned transportation. Determining whether the vehicle has ended the portion of the planned transportation in compliance with the planned transportation comprises: obtaining a fourth current location of the vehicle, transmitting the fourth current location of the vehicle to the server for determining if the vehicle has ended the portion of the planned transportation in compliance with the planned transportation, and receiving from the server the determination of whether the vehicle has ended the portion of the planned transportation in compliance with the planned transportation.

As described, in some embodiments, the methods 400, 420, and 440 may respectively correspond to steps performed by a server, a computing device of a first user, and a computing device of a second user. The methods 400, 420, and 440 may correspond to the steps described above with reference to FIG. 2A to FIG. 3J. The first user may drive a private vehicle for an entity's purpose, and the second user may share the ride for at least a part of the first user's transportation. The second user's ride may also be for the entity's purpose. And both the first and the second users are compensated by the entity.

FIG. 4D illustrates a flowchart of an exemplary method 420 for monitoring vehicle usage, according to various embodiments of the present disclosure. The method 460 may be implemented in various environments including, for example, the environment 100 of FIG. 1. The exemplary method 460 may be implemented by one or more components of the system 102 (e.g., the processor 104, the memory 106). An exemplary system 102 may include a server. The exemplary method 460 may be implemented by multiple systems similar to the system 102. The operations of method 460 presented below are intended to be illustrative. Depending on the implementation, the exemplary method 460 may include additional, fewer, or alternative steps performed in various orders or in parallel.

At block 462, a planned transportation to be carried out by a vehicle associated with a first user may be determined. At block 464, tracking data of the vehicle may be obtained to determine whether the vehicle has started and ended the transportation in compliance with the planned transportation. At block 466, in response to determining that the vehicle has started and ended the transportation in compliance with the planned transportation, a first reward may be transferred to the first user.

In some embodiments, the vehicle is a private property of the first user. The first user is affiliated with an entity. The first user is in the vehicle during at least a segment of the transportation (e.g., the first user is a driver who drives from the departure location to the destination). The planned transportation is at least in part to the entity's benefit or otherwise causes the entity to subsidize the transportation. For example, the first user may drive her private car to conduct business for the entity, and the entity would like to reimburse for the first user's cost.

In some embodiments, prior to obtaining the tracking data of the vehicle, the method further comprises: determining the first reward; providing the planned transportation and the determined first reward (e.g., a determined budget for reimbursing the planned transportation) to the entity for approval; and enabling the obtaining the tracking data only after receiving an approval of the planned transportation from the entity.

In some embodiments, prior to obtaining the tracking data of the vehicle, the method further comprises: determining at least one second user to share the vehicle for at least a portion of the planned transportation, wherein the at least one second user is affiliated with the entity; and in response to determining that the second user has completed the portion of the planned transportation, transferring a second reward to the at least one second user.

In some embodiments, determining the planned transportation to be carried out by the vehicle associated with the first user comprises obtaining from a computing device of the first user the planned transportation to be carried out by the vehicle associated with the first user. In some embodiments, the planned transportation (e.g., planned departure time, planned departure location, and/or planned destination) as obtained from the computing device of the first user may be approved by the entity, and the approved planned transportation is used for the compliance verification in the block 466. Optionally, some conditions (e.g., a planned departure time) of the planned transportation after the first approval by the entity may be altered, for example, when a second user is added to the ride, and the once approved planned transportation may be sent to the entity for another approval. Thus, the planned transportation used for verification in the block 466 may refer to twice approved planned transportation. Alternatively, the entity may opt to waive the first and/or the second approval processes.

In some embodiments, prior to obtaining the tracking data of the vehicle, the method further comprises: determining at least one second user to share the vehicle for at least a portion of the planned transportation, wherein the at least one second user is affiliated with the entity; and in response to determining that the second user has completed the portion of the planned transportation, transferring a second reward to the at least one second user. Details of adding the second user can be referred to FIG. 3F and other descriptions above.

FIG. 4E illustrates a flowchart of an exemplary method 480 for monitoring vehicle usage, according to various embodiments of the present disclosure. The method 480 may be implemented in various environments including, for example, the environment 100 of FIG. 1. The exemplary method 480 may be implemented by the computing device 110 (e.g., a mobile phone of a first user). The operations of method 480 presented below are intended to be illustrative. Depending on the implementation, the exemplary method 480 may include additional, fewer, or alternative steps performed in various orders or in parallel.

At block 482, information of a vehicle for providing transportation may be transmitted to a server for determining a planned transportation. At block 484, at least one second user may be determined to share the vehicle for at least a portion of the planned transportation, wherein the at least one second user is affiliated with the entity. At block 486, the at least one second user may be caused to receive an invitation to share the vehicle for at least the portion of the planned transportation. At block 488, tracking data of a computing device of a first user as tracking data of the vehicle may be transmitted to the server for determining whether the vehicle has started and ended the transportation in compliance with the planned transportation. At block 490, a first reward may be obtained, if the vehicle has started and ended the transportation in compliance with the planned transportation.

In some embodiments, the vehicle is a private property of the first user. The first user is affiliated with an entity. The first user is in the vehicle during at least a segment of the planned transportation.

In some embodiments, prior to transmitting tracking data of the computing device as tracking data of the vehicle to the server for determining whether the vehicle has started and ended the transportation in compliance with the planned transportation, the method further comprises: enabling the determination of whether the vehicle has started and ended the transportation in compliance with the planned transportation only after receiving an approval of the planned transportation from the entity.

In some embodiments, transmitting tracking data of the computing device as tracking data of the vehicle to the server for determining whether the vehicle has started the transportation in compliance with the planned transportation comprises: obtaining at least one of a first current time or a first current location of the computing device, transmitting at least one of the first current time or the first current location of the computing device to the server for determining if the vehicle has started the transportation in compliance with the planned transportation, and receiving from the server the determination of whether the vehicle has started the transportation in compliance with the planned transportation.

In some embodiments, transmitting tracking data of the computing device as tracking data of the vehicle to the server for determining whether the vehicle has ended the transportation in compliance with the planned transportation comprises: obtaining a second current location of the computing device, transmitting the second current location of the computing device to the server for determining if the vehicle has ended the transportation in compliance with the planned transportation, and receiving from the server the determination of whether the vehicle has ended the transportation in compliance with the planned transportation.

FIG. 4F illustrates a flowchart of an exemplary method 499 for monitoring vehicle usage, according to various embodiments of the present disclosure. The method 499 may be implemented in various environments including, for example, the environment 100 of FIG. 1. The exemplary method 499 may be implemented by the computing device 111 (e.g., a mobile phone of a second user). The operations of method 499 presented below are intended to be illustrative. Depending on the implementation, the exemplary method 499 may include additional, fewer, or alternative steps performed in various orders or in parallel.

At block 491, a transportation request may be transmitted to a server for determining a planned transportation in a vehicle, where the planned transportation comprises a portion for transporting the second user. At block 492, information of the vehicle matching the transportation request may be received (e.g., from a computing device of a first user). At block 493, an acceptance for sharing the vehicle for the portion of the planned transportation may be transmitted (e.g., to a computing device of a first user or a server). At block 494, tracking data of the computing device as tracking data of the vehicle may be transmitted to the server for determining whether the vehicle has started and ended the portion of the planned transportation in compliance with the planned transportation. At block 495, a second reward may be obtained, if the vehicle has started and ended the portion of the planned transportation in compliance with the planned transportation.

In some embodiments, the vehicle is a private property of a first user. The first user and the second user are affiliated with an entity. The first user and the second user are in the vehicle during the portion of the planned transportation.

In some embodiments, prior to transmitting tracking data of the computing device as tracking data of the vehicle to the server for determining whether the vehicle has started and ended the portion of the planned transportation in compliance with the planned transportation, the method further comprises: enabling the determination of whether the vehicle has completed the portion of the planned transportation in compliance with the planned transportation only after receiving an approval of the planned transportation from the entity.

In some embodiments, transmitting tracking data of the computing device as tracking data of the vehicle to the server for determining whether the vehicle has started the portion of the planned transportation in compliance with the planned transportation comprises: obtaining a third current location of the computing device, transmitting the third current location of the computing device to the server for determining if the vehicle has started the portion of the planned transportation in compliance with the planned transportation, and receiving from the server the determination of whether the vehicle has started the portion of the planned transportation in compliance with the planned transportation.

In some embodiments, transmitting tracking data of the computing device as tracking data of the vehicle to the server for determining whether the vehicle has ended the portion of the planned transportation in compliance with the planned transportation comprises: obtaining a fourth current location of the computing device, transmitting the fourth current location of the computing device to the server for determining if the vehicle has ended the portion of the planned transportation in compliance with the planned transportation, and receiving from the server the determination of whether the vehicle has ended the portion of the planned transportation in compliance with the planned transportation.

The methods 460, 480, and 499 may respectively correspond to steps performed by a server, a computing device of a first user, and a computing device of a second user. The methods 460, 480, and 499 may correspond to the steps described above with reference to FIG. 2A to FIG. 3J. The first user may drive a private vehicle for an entity's purpose, and optionally the second user may share the ride for at least a part of the first user's transportation. The second user's ride may also be for the entity's purpose. And both the first and the second users are compensated by the entity.

As described, the disclosed systems and methods can mitigate or overcome the disadvantages of current technologies. In the past, managing and verifying private vehicle usages for entity purposes was impractical for the significant burden of manually sorting and checking information and the unreliability of self-reporting. Empowered by the disclosed systems and methods, entities can effectively manage private vehicle compensation programs. Assembled in a centralized system, application approval, budget control, vehicle usage monitoring, and reward transfer can be achieved in a streamlined fashion, with a vast reduction in the operation cost, increase of work efficiency, and enhancement of employee morale.

The techniques described herein are implemented by one or more special-purpose computing devices. The special-purpose computing devices may be desktop computer systems, server computer systems, portable computer systems, handheld devices, networking devices or any other device or combination of devices that incorporate hard-wired and/or program logic to implement the techniques. Computing device(s) are generally controlled and coordinated by operating system software. Conventional operating systems control and schedule computer processes for execution, perform memory management, provide file system, networking, I/O services, and provide a user interface functionality, such as a graphical user interface (“GUI”), among other things.

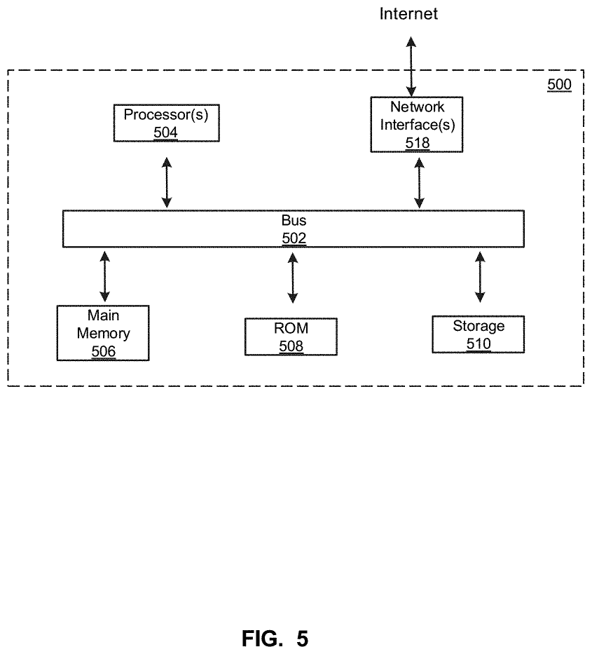

FIG. 5 is a block diagram that illustrates a computer system 500 upon which any of the embodiments described herein may be implemented. The system 500 may correspond to the system 102 described above. The computer system 500 includes a bus 502 or other communication mechanism for communicating information, one or more hardware processors 504 coupled with bus 502 for processing information. Hardware processor(s) 504 may be, for example, one or more general purpose microprocessors. The processor(s) 504 may correspond to the processor 104 described above.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions. The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions. The main memory 506, the ROM 508, and/or the storage 510 may correspond to the memory 106 described above.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The main memory 506, the ROM 508, and/or the storage 510 may include non-transitory storage media. The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 500 also includes a network interface 518 coupled to bus 502. Network interface 518 provides a two-way data communication coupling to one or more network links that are connected to one or more local networks. For example, network interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

The computer system 500 can send messages and receive data, including program code, through the network(s), network link and network interface 518. In the Internet example, a server might transmit a requested code for an application program through the Internet, the ISP, the local network and the network interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some exemplary embodiments, the processors or processor-implemented engines may be located in a single geographic location (e.g., within a home environment, an office environment, or a server farm). In other exemplary embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A method for monitoring vehicle usage implementable by a server, the method comprising:
obtaining information of one or more vehicles available to provide transportation and one or more transportation requests;
matching one or more of the transportation requests with one of the one or more vehicles to determine a planned transportation;
determining a first reward to a first user associated with the matched vehicle and a second reward to one or more second users associated with the matched transportation requests;
obtaining tracking data of the matched vehicle to determine whether the matched vehicle has started and ended a transportation in compliance with the planned transportation; and
in response to determining that the matched vehicle has started and ended the transportation in compliance with the planned transportation, transferring the first reward to the first user and transferring the second reward to the one or more second users.

2. The method of claim 1, wherein:
the matched vehicle is a private property of the first user;
the first user and the one or more second users are affiliated with an entity; and
the first user and the one or more second users are in the vehicle during at least one segment of the planned transportation.

3. The method of claim 2, prior to the obtaining the tracking data of the matched vehicle, further comprising:
determining the first reward and the second reward;
providing information of the planned transportation to the entity for approval, the information of the planned transportation including at least one of: the matched vehicle, the matched transportation requests, the first user, the one or more second users, the first reward, or the second reward; and
enabling the obtaining the tracking data only after receiving an approval of the planned transportation from the entity.

4. The method of claim 1, wherein the determining the planned transportation comprises:
determining at least one of a planned departure time for the planned transportation, a planned departure location for the planned transportation, or a planned destination for the planned transportation.

5. The method of claim 4, wherein the obtaining the tracking data of the matched vehicle to determine whether the matched vehicle has started and ended the transportation in compliance with the planned transportation comprises:
obtaining at least one of a first current time of the vehicle or a first current location of the vehicle, to determine if the vehicle has started the transportation based on at least one of: comparing the planned departure time with the first current time, or comparing the planned departure location with the first current location; and
obtaining a second current location of the vehicle, to determine if the vehicle has ended the transportation based on comparing the planned destination with the second current location.

6. The method of claim 5, wherein:
the obtaining the first current time comprises: in response to receipt of an indication of starting the transportation from a computing device associated with the first user, obtaining the first current time;
the obtaining the first current location of the vehicle comprises: in response to receipt of the indication of starting the transportation from the computing device, obtaining a first current location of the computing device as the first current location of the vehicle; and
the obtaining the second current location of the vehicle comprises: in response to receipt of an indication of ending the transportation from the computing device, obtaining a second current location of the computing device as the second current location of the vehicle.

7. The method of claim 5, wherein:
the comparing the planned departure time with the first current time comprises: comparing a time difference between the planned departure time and the first current time with a time threshold;
the comparing the planned departure location with the first current location comprises: comparing a first geographic distance between the planned departure location and the first current location with a first distance threshold; and
the comparing the planned destination with the second current location comprises: comparing a second geographic distance between the planned destination and the second current location with a second distance threshold.

8. The method of claim 7, further comprising:
in response to at least one of the time difference exceeding the time threshold or the first geographic distance exceeding the first distance threshold, causing the computing device to render a notification that the planned transportation has not started; and
in response to the second geographic distance exceeding the second distance threshold, causing the computing device to render a notification that the planned transportation has not ended.

9-14. (canceled)

15. A method for monitoring vehicle usage implementable by a computing device of a second user, the method comprising:
transmitting a transportation request to a server for determining a planned transportation in a vehicle, where the planned transportation comprises a portion for transporting the second user;
determining whether the vehicle has started and ended the portion of the planned transportation in compliance with the planned transportation; and
obtaining a second reward, if the vehicle has started and ended the portion of the planned transportation in compliance with the planned transportation.

16. The method of claim 15, wherein:
the vehicle is a private property of a first user;
the first user and the second user are affiliated with an entity; and
the first user and the second user are in the vehicle during the portion of the planned transportation.

17. The method of claim 16, prior to the determining whether the vehicle has started and ended the portion of the planned transportation in compliance with the planned transportation, further comprising:
enabling the determination of whether the vehicle has completed the portion of the planned transportation in compliance with the planned transportation only after receiving an approval of the planned transportation from the entity.

18. The method of claim 16, prior to the determining whether the vehicle has started and ended the portion of the planned transportation in compliance with the planned transportation, further comprising:
receiving information of the vehicle matching the transportation request; and
transmitting an acceptance for sharing the vehicle for the portion of the planned transportation.

19. The method of claim 15, wherein:
the determining whether the vehicle has started the portion of the planned transportation in compliance with the planned transportation comprises: obtaining a planned departure location for the second user and a third current location of the vehicle to determine if the vehicle has started the portion of the planned transportation in compliance with the planned transportation; and
the determining whether the vehicle has ended the portion of the planned transportation in compliance with the planned transportation comprises: obtaining a planned destination for the second user and a fourth current location of the vehicle to determine if the vehicle has ended the portion of the planned transportation in compliance with the planned transportation.

20. The method of claim 15, wherein:
the determining whether the vehicle has started the portion of the planned transportation in compliance with the planned transportation comprises:
obtaining a third current location of the vehicle,
transmitting the third current location of the vehicle to the server for determining if the vehicle has started the portion of the planned transportation in compliance with the planned transportation, and
receiving from the server the determination of whether the vehicle has started the portion of the planned transportation in compliance with the planned transportation; and
the determining whether the vehicle has ended the portion of the planned transportation in compliance with the planned transportation comprises:
obtaining a fourth current location of the vehicle,
transmitting the fourth current location of the vehicle to the server for determining if the vehicle has ended the portion of the planned transportation in compliance with the planned transportation, and
receiving from the server the determination of whether the vehicle has ended the portion of the planned transportation in compliance with the planned transportation.
